(19) United States
(12) Patent Application Publication
(10) Pub. No.: US 2026/0255200 A1
(43) Pub. Date: Aug. 27, 2026

(54) POLICY MANAGEMENT IN A WIRELESS COMMUNICATION NETWORK

(71) Applicant: Lenovo (Singapore) Pte. Limited, Singapore (SG)

(72) Inventors: Dimitrios Karampatsis, Ruislip (GB); Andreas Kunz, Ladenburg (DE)

(73) Assignee: Lenovo (Singapore) Pte. Limited, Singapore (SG)

(21) Appl. No.: 18/872,417

(22) PCT Filed: Aug. 8, 2022
(86) PCT No.: PCT/EP2022/072280

§ 371 Date: Dec. 6, 2024

(30) Foreign Application Priority Data
Jun. 10, 2022 (GR) 20220100482

(51) Int. Cl. H04W 24/10; H04W 24/08; H04W 40/24

(52) U.S. Cl. CPC H04W 24/10; H04W 24/08; H04W 40/24

(57) ABSTRACT

There is provided herein a UE-PCF comprising a transceiver arranged to: send a first request to an SM-PCF, the request instructing the SM-PCF to monitor UE traffic for an established PDU session to a specific S-NSSAI/DNN; and receive a report of non-allowed traffic from the SM-PCF that allows the UE-PCF to identify if a URSP rule is not enforced correctly by the UE.

### FIELD

The subject matter disclosed herein relates generally to the field of implementing policy management in a wireless communication network. This document defines a UE-PCF, a method in a UE-PCF, an SM-PCF, and a method in an SM-PCF.

### BACKGROUND

In 3GPP networks a Policy Control Function (PCF) has the following responsibilities:
Policy rules for application and service data flow detection, gating, QoS, and flow based charging to the Session Management Function (“SMF”);
Access and Mobility Management related policies to the Access and Mobility Management Function (“AMF”); and
Provisioning of UE policies (i.e. UE Route Selection Policy (URSP) rules) to the UE via the AMF.

There can be two PCF entities that are invoked when a UE registers to a 3GPP network. During registration, the AMF selects and establish an AM Policy association) with a PCF (also known as UE-PCF) to receive Access and Mobility related policies. The same PCF (UE-PCF) may also include UE policies that are sent transparently to the UE via the AMF. In addition, when the UE requests establishment of a PDU session the SMF selects and establishes a SM Policy association, with another PCF (also known as SM-PCF) to receive session management related policies (i.e. Policy rules). The SM-PCF and UE-PCF selected may be part of the same logical PCF but in most deployments the UE-PCF and SM-PCF functions are provided by different logical PCFs. For example, there may be an SM-PCF implementation per network slice supported by the 3GPP network operator.

Since Release 15 onwards of the 3GPP specifications URSP rules have been defined to allow a UE to determine how to route application traffic through a mobile communication network either via 3GPP access or via non- 3GPP access with the options of an untrusted or trusted WLAN access or to route the traffic non-seamlessly bypassing the mobile communication network via a WLAN connection. The URSP rules and the procedures for the UE to apply URSP rules are described in 3GPP TS 23.502 v17.4.0 and 3GPP TS 23.503 v17.4.0 (URSP rules definitions and procedures are included from version 15.0.0 onwards of 23.502 and 23.503).

S2-2204417 is a 3GPP discussion document submitted by Lenovo describes an arrangement whereby an SM-PCF configures the User Plane Function (“UPF”) to inspect non-allowed traffic in a PDU session. S2-2202467 and S2-2203115 are related contributions.

S2 -2203892 is a 3GPP discussion document submitted by Ericsson at SA #151 and describes the SM-PCF selecting a UE-PCF for the purpose to provide UE policy container provided by the UE when the UE attaches in EPC.

### SUMMARY

A problem with URSP rules is that they may not be applied correctly by a UE. Incorrect application might be due to a poorly drafted URSP rule, some change in the application traffic intended to be caught by the rule, the UE being provisioned with an out-of-date URSP rule, and/or a malicious UE deliberately ignoring a URSP rule provisioned to it. A mechanism to detect whether a UE is applying a URSP rule correctly is required.

Disclosed herein are procedures for policy management in a wireless communication network. Said procedures may be implemented by a UE-PCF, a method in a UE-PCF, an SM-PCF, and a method in an SM-PCF.

There is provided a UE-PCF comprising a transceiver arranged to: send a first request to an SM-PCF, the request instructing the SM-PCF to monitor UE traffic for an established PDU session to a specific S-NSSAI/DNN (Single-Network Slice Assistance Information/Data Network Name); and receive a report of non-allowed traffic from the SM-PCF that allows the UE-PCF to identify if a URSP rule is not enforced correctly by the UE.

There is further provided a method in a UE-PCF, the method comprising: sending a first request to an SM-PCF, the first request instructing the SM-PCF to monitor UE traffic for an established PDU session to a specific S-NSSAI/DNN; and receiving a report of non-allowed traffic from the SM-PCF that allows the UE-PCF to identify if a URSP rule is not enforced correctly by the UE.

There is further provided an SM-PCF comprising a transceiver arranged to: receive a first request from a UE-PCF, the request instructing the SM-PCF to monitor UE traffic for an established PDU session to a specific S-NSSAI/DNN; and send a report of non-allowed traffic to the UE-PCF, the report allowing the UE-PCF to identify if a URSP rule is not enforced correctly by the UE.

There is further provided a method in an SM-PCF, the method comprising: receiving a first request from a UE-PCF, the request instructing the SM-PCF to monitor UE traffic for an established PDU session to a specific S-NSSAI/DNN; and sending a report to the UE-PCF of non-allowed traffic, the report allowing the UE-PCF to identify if a URSP rule is not enforced correctly by the UE.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for policy management in a wireless communication network will now be described, by way of example only, with reference to the accompanying drawings, in which:

FIG. 1 is a schematic block diagram illustrating one embodiment of a wireless communication system for policy management in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a UE-PCF;

FIG. 5 illustrates a method in an SM-PCF;

FIG. 6 is a messaging diagram illustrating a process for policy management in a wireless communication network; and

FIG. 7 is a messaging diagram illustrating another process for policy management in a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

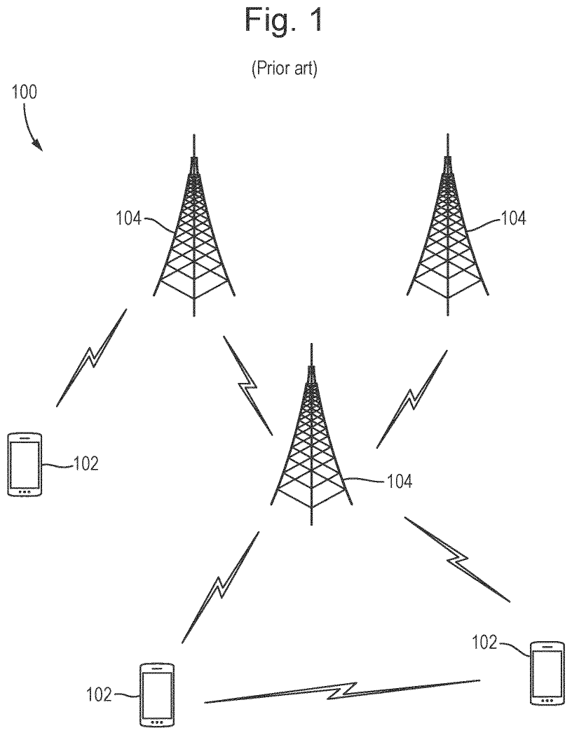

FIG. 1 depicts an embodiment of a wireless communication system 100 for policy management in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

The remote units 102 may comprise a user equipment apparatus 200, a UE 602, or a UE 702 as described herein. In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may comprise a network node 300, a UE-PCF 604, an SM-PCF 612, an SM-PCF 704 or a UE-PCF 712 as described herein. The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, a Session Management Function (“SMF”), an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

Since Release 15 onwards of the 3GPP Standard Specifications, User Equipment Route Selection Policy (“URSP”) rules have been defined to allow a UE to determine how to route application traffic. Application traffic can be routed via:
the mobile communication network by way of 3GPP access,
the mobile communication network by way of non-3GPP access,
an untrusted WLAN access,
a trusted WLAN access, and/or
a WLAN connection traffic non-seamlessly bypassing the mobile communication network.

The URSP rules and the procedures for the UE to apply URSP rules are described in 3GPP TS 23.502 v17.4.0 and 3GPP TS 23.503v17.4.0 . The URSP rules contain a Traffic Descriptor that allows the UE to determine if a URSP rule matches application traffic. Application traffic is network traffic associated with an application. Traffic Descriptors include Application Descriptors which may define the operating system identity (“OSID”) and the application identity (“OSAppID”). Traffic Descriptors also include IP flow descriptors such as the target address of application traffic, a requested Data Network Name by the application, and/or a connection capability requested by an application (e.g. an IMS connection).

Each URSP rule contains a Route Selection Descriptor (“RSD”) that describes to the UE how to route the Protocol Data Unit (“PDU”) session. The RSD includes one or more of the following: Session and Service Continuity (“SSC”) Mode Selection, Network Slice Selection, Data Network Name (“DNN”) Selection, PDU Session Type Selection, Non-Seamless Offload indication, Access Type preference.

In 3GPP networks a Policy Control Function (“PCF”) has the following responsibilities:
Policy rules for application and service data flow detection, gating, QoS, and flow based charging to the SMF;
Access and Mobility Management related policies to the AMF; and
Provisioning of UE policies (i.e. UE Route Selection Policy (“URSP”) rules) to the UE via the AMF.

Since Release 15 onwards of the 3GPP specifications URSP rules have been defined to allow a UE to determine how to route application traffic through a mobile communication network either via 3GPP access or via non- 3GPP access with the options of an untrusted or trusted WLAN access or to route the traffic non-seamlessly bypassing the mobile communication network via a WLAN connection. The URSP rules and the procedures for the UE to apply URSP rules are described in 3GPP TS 23.502 v17.4.0 and 3GPP TS 23.503 v17.4.0 (URSP rules definitions and procedures are included from version 15.0.0 onwards of 23.502 and 23.503).

The solution presented herein addresses the issue of how a consumer (i.e. PCF) can be aware of which UEs do not enforce the provisioned URSP rules correctly. This is done by requesting that the UPF monitors UE traffic when a UE establishes a PDU session to a specific S-NSSAI/DNN.

Up to now there can be two PCF entities that are invoked when the UE registers to the 3GPP network. During registration, the AMF selects and establish an AM Policy association) with a PCF (also known as UE-PCF) to receive Access and Mobility related policies. The same PCF (UE-PCF) may also include UE policies that are sent transparently to the UE via the AMF. In addition, when the UE requests establishment of a PDU session the SMF selects and establishes a SM Policy association, with another PCF (also known as SM-PCF) to receive session management related policies (i.e. Policy rules). The SM-PCF and UE-PCF selected may be part of the same logical PCF but in most deployments the UE-PCF and SM-PCF functions are provided by different logical PCFs. For example, there may be an SM-PCF implementation per network slice supported by the 3GPP network operator.

As part of the UE Policy enhancement work in Release 18, one of the objectives is to identify how to detect that a UE enforces a URSP rule correctly. One of the solutions presented is that the SM-PCF instructs the network to monitor on the PDU session established if the UE routes traffic according to a URSP rule. However, it has not been clearly defined how the SM-PCF is configured to inspect traffic of a PDU session.

The present application presents a solution to this problem.

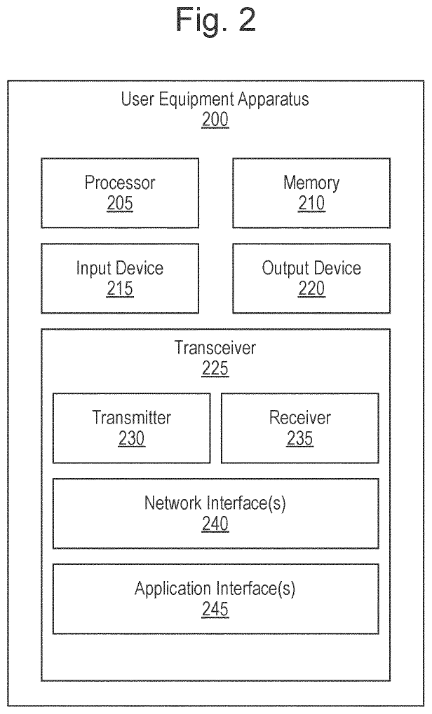

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 may comprise a remote unit 102, a UE 602, or a UE 702 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

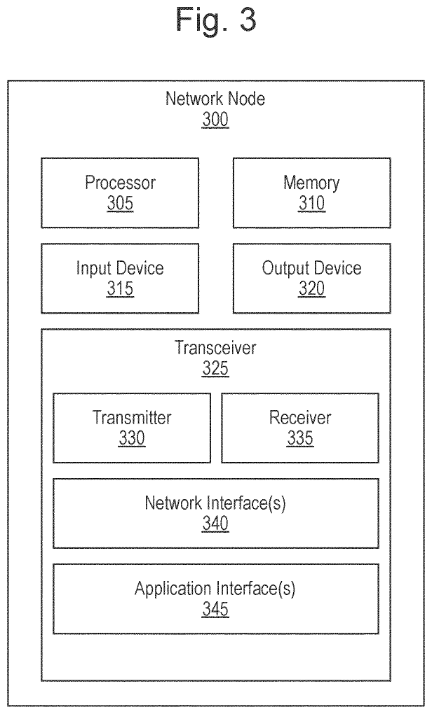

FIG. 3 depicts further details of the network node 300 that may be used for implementing the methods described herein. The network node 300 may comprise a network unit 104, a UE-PCF 604, an SM-PCF 612, an SM-PCF 704 or a UE-PCF 712 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

There is provided a UE-PCF comprising a transceiver arranged to: send a first request to an SM-PCF, the request instructing the SM-PCF to monitor UE traffic for an established PDU session to a specific S-NSSAI/DNN; and receive a report of non-allowed traffic from the SM-PCF that allows the UE-PCF to identify if a URSP rule is not enforced correctly by the UE.

The specific S-NSSAI/DNN may be any network resource defined in a traffic descriptor of a URSP rule. The first request instructing the SM-PCF to monitor UE traffic when a UE establishes a PDU session to a specific S-NSSAI/DNN may comprise an indication to report non-allowed traffic. The first request instructing the SM-PCF to monitor UE traffic when a UE establishes a PDU session to a specific S-NSSAI/DNN may comprise an indication of allowed traffic via the S-NSSAI/DNN. The report of non-allowed traffic may comprise a list of service data flows that are routed incorrectly by the device via the PDU session.

The transceiver may be further arranged to send a preliminary request to a first network function wherein the preliminary request requests an identity of the SM-PCF that provides session management policies when a device requests a network connection to a first list of S-NSSAI/DNNs. The transceiver may be further arranged to receive an identity of the second network function in response to the UE requesting a network connection to one of the first list of S-NSSAI/DNNs. The first network function may be a BSF. The preliminary request is different to the first request. The preliminary request, if needed, is sent before the first request.

The UE-PCF may further comprise a processor, wherein the processor is further arranged to define allowed traffic via the requested UE network connection based on a URSP rule provisioned to the UE.

The first request may comprise instructions to install session management policies.

The first request may further comprise instructions to report an occurrence of an event identified by a first event identifier.

The first event identifier may identify an occurrence where the UE routes non-allowed traffic via the established PDU session.

The transceiver may be further arranged to receive a usage monitoring identifier from a UDR. The usage monitoring identifier received from the UDR may be based on subscription information of the UE. The usage monitoring identifier may comprise an indication of a policy to monitor usage of non-allowed traffic.

The request instructing the SM-PCF to monitor UE traffic when a UE establishes a PDU session to a specific S-NSSAI/DNN may include the usage monitoring identifier from the UDR.

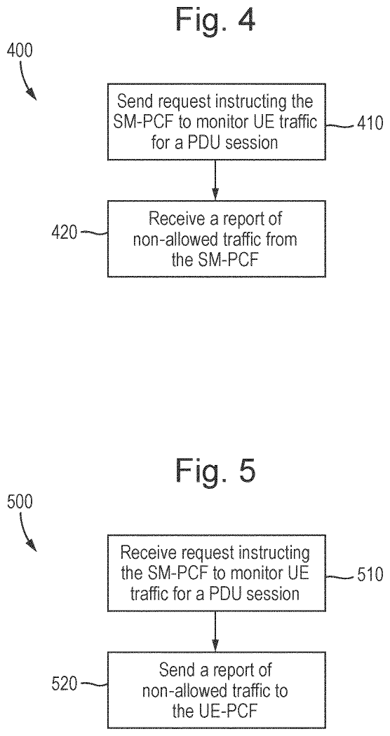

FIG. 4 illustrates a method 400 in a UE-PCF. The UE-PCF may comprise a network unit 104, network node 300, a UE-PCF 604, or a UE-PCF 712 as described herein. The method 400 comprises sending 410 a first request to an SM-PCF, the first request instructing the SM-PCF to monitor UE traffic for an established PDU session to a specific S-NSSAI/DNN. The method 400 further comprises receiving 420 a report of non-allowed traffic from the SM-PCF that allows the UE-PCF to identify if a URSP rule is not enforced correctly by the UE.

The first request instructing the SM-PCF to monitor UE traffic when a UE establishes a PDU session to a specific S-NSSAI/DNN may comprise an indication to report non-allowed traffic. The first request instructing the SM-PCF to monitor UE traffic when a UE establishes a PDU session to a specific S-NSSAI/DNN may comprise an indication of allowed traffic via the S-NSSAI/DNN. The report of non-allowed traffic may comprise a list of service data flows that are routed incorrectly by the device via the PDU session.

The method 400 may further comprise sending a preliminary request to a first network function wherein the preliminary request includes a request for providing an identity of the SM-PCF that provides session management policies when a device requests a network connection to a first list of S-NSSAI/DNNs; and receiving an identity of the second network function in response to the UE requesting a network connection to one of the first list of S-NSSAI/DNNs. The first network function may be a BSF.

The method 400 may further comprise defining allowed traffic via the requested UE network connection based on a URSP rule provisioned to the UE.

The first request may further comprise instructions to install session management policies. The first request may further comprise instructions to report an occurrence of an event identified by a first event identifier. The first event identifier may identify an occurrence where the UE routes non-allowed traffic via the established PDU session.

The method 400 may further comprise receiving a usage monitoring identifier from a UDR.

The usage monitoring identifier received from the UDR may be based on subscription information of the UE. The usage monitoring identifier may comprise an indication of a policy to monitor usage of non-allowed traffic.

The request instructing the SM-PCF to monitor UE traffic when a UE establishes a PDU session to a specific S-NSSAI/DNN may include the usage monitoring identifier from the UDR.

There is further provided an SM-PCF comprising a transceiver arranged to: receive a first request from a UE-PCF, the request instructing the SM-PCF to monitor UE traffic for an established PDU session to a specific S-NSSAI/DNN; and send a report of non-allowed traffic to the UE-PCF, the report allowing the UE-PCF to identify if a URSP rule is not enforced correctly by the UE.

The first request instructing the SM-PCF to monitor UE traffic when a UE establishes a PDU session to a specific S-NSSAI/DNN may comprise an indication to report non-allowed traffic. The first request instructing the SM-PCF to monitor UE traffic when a UE establishes a PDU session to a specific S-NSSAI/DNN may comprise an indication of allowed traffic via the S-NSSAI/DNN. The report of non-allowed traffic may comprise a list of service data flows that are routed incorrectly by the device via the PDU session.

The first request may comprise instructions to install session management policies. The first request may further comprise instructions to report an occurrence of an event identified by a first event identifier. The first event identifier may identify an occurrence where the UE routes non-allowed traffic via the established PDU session.

The transceiver may be further arranged to receive a usage monitoring identifier from a UDR. The usage monitoring identifier received from the UDR may be based on subscription information of the UE. The usage monitoring identifier may comprise an indication of a policy to monitor usage of non-allowed traffic.

The request instructing the SM-PCF to monitor UE traffic when a UE establishes a PDU session to a specific S-NSSAI/DNN may include the usage monitoring identifier from the UDR.

FIG. 5 illustrates a method 500 in an SM-PCF. The SM-PCF may comprise a network unit 104, network node 300, an SM-PCF 612, or an SM-PCF 704 as described herein. The method 500 comprises receiving 510 a first request from a UE-PCF, the request instructing the SM-PCF to monitor UE traffic for an established PDU session to a specific S-NSSAI/DNN. The method 500 further comprises sending 520 a report to the UE-PCF of non-allowed traffic, the report allowing the UE-PCF to identify if a URSP rule is not enforced correctly by the UE.

The first request instructing the SM-PCF to monitor UE traffic when a UE establishes a PDU session to a specific S-NSSAI/DNN may comprise an indication to report non-allowed traffic. The first request instructing the SM-PCF to monitor UE traffic when a UE establishes a PDU session to a specific S-NSSAI/DNN may comprise an indication of allowed traffic via the S-NSSAI/DNN. The report of non-allowed traffic may comprise a list of service data flows that are routed incorrectly by the device via the PDU session.

The first request may include instructions to install session management policies. The first request may further comprise instructions to report an occurrence of an event identified by a first event identifier. The first event identifier may identify an occurrence where the UE routes non-allowed traffic via the established PDU session.

The method 500 may further comprise receiving a usage monitoring identifier from a UDR.

The usage monitoring identifier received from the UDR may be based on subscription information of the UE. The usage monitoring identifier may comprise an indication of a policy to monitor usage of non-allowed traffic.

The request instructing the SM-PCF to monitor UE traffic when a UE establishes a PDU session to a specific S-NSSAI/DNN may include the usage monitoring identifier from the UDR.

According to one arrangement, a UE-PCF configures an SM-PCF with policies to report non-allowed traffic. The UE-PCF allocates and provisions URSP rules to identify if a URSP rule is enforced correctly by the UE.

The UE-PCF subscribes from the network to be notified the address of the SM-PCF selected for the PDU session established by a UE to an S-NSSAI/DNN that is part of the route selection descriptor of the URSP rule. The UE-PCF then requests the SM-PCF reports non-allowed traffic. There are different alternatives on how such request can be supported, three example options are described in the following.

According to option 1, the UE-PCF sends an Npcf_Policy Authorization_request service operation and the UE-PCF includes in the request the following parameters: UE ID; Allowed Traffic; and an Identifier indicating to initiate usage monitoring and report traffic that does not match to the allowed traffic.

A usage monitoring key may be provided to configure the SMF/UPF to report the sum of data as per usage monitoring procedures defined in 3GPP TS 23.503. The UPF would report a volume of data of non-allowed traffic sent by the UE via this PDU session.

According to option 2, the UE-PCF uses the event exposure mechanism and subscribes to be notified when traffic not matching the allowed traffic is detected. The request includes the following parameters: UE ID; Event ID indicating to report traffic not matching the allowed traffic; and Allowed Traffic.

According to option 3, a new Service Based Interface (“SBI”) between the UE-PCF and SM-PCF is provided that includes the parameters mentioned in option 1 and/or option 2.

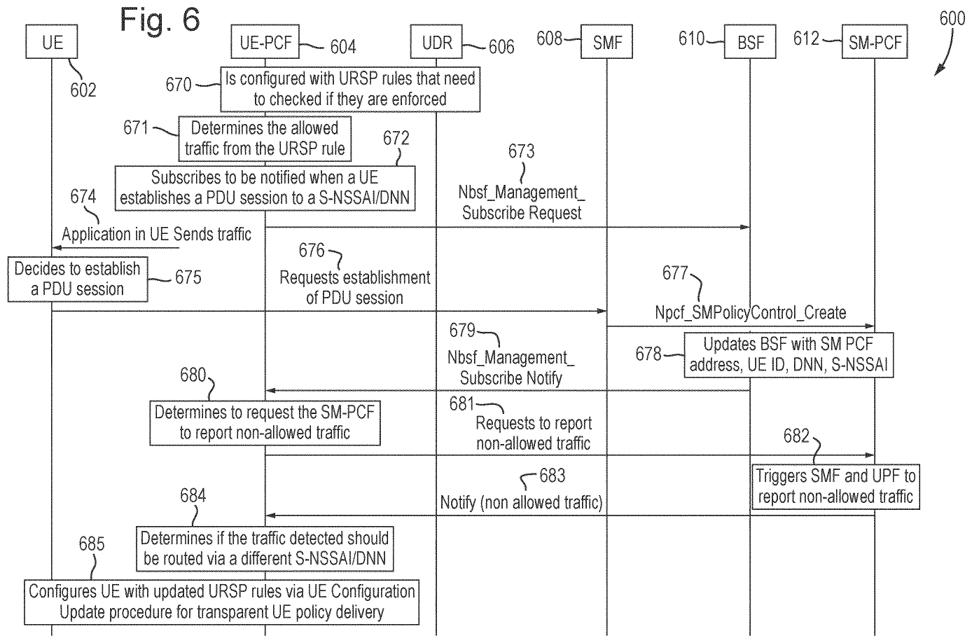

The SM-PCF reports non-allowed traffic to the UE-PCF that allows the UE-PCF to determine if a URSP rule is not enforced correctly by the UE. Once a positive determination is made that a UE is not enforcing a particular URSP rule, the UE-PCF may decide to provision updated URSP rules to the UE. FIG. 6 is a messaging diagram illustrating such a process 600 for policy management in a wireless communication network.

The system illustrated in FIG. 6 shows a UE 602, a UE-PCF 604, a UDR 606, an SMF 608, a BSF 610, and an SM-PCF 612. The UE 602 may comprise a remote unit 102, a user equipment apparatus 200 or a UE 702 as described herein. The UE-PCF 604 and the SM-PCF 612 may each comprise a network unit 104, network node 300 as described herein.

The process 600 starts at 670, where the UE-PCF 604 determines to check if the UE 602 or any UE or a group of UEs routes traffic according to a configured URSP rule. This may be facilitated by the UDR providing the URSP rules based on a UE subscription, as illustrated in FIG. 6. Alternatively, the UE-PCF may be configured via an Operations, Administration and Maintenance (OAM) with instructions to monitor traffic when the UE establishes a PDU session to a specific S-NSSAI/DNN. The instructions may also include information about the allowed traffic via such a PDU session.

At 671, the UE-PCF 604 determines the traffic allowed from the URSP rule.

At 672, the UE-PCF 604 subscribes from the BSF 610 to be informed when the SM-PCF 612 is selected due to the UE 602 requesting a PDU session to the S-NSSAI/DNN according to the configured URSP rule.

At 673, the UE-PCF 604 sends an Nbsf_Management_Subscribe request message to the BSF. The Nbsf_Management_Subscribe request message may comprise SUPI, GPSI, UE ID, and or S-NSSAI/DNN.

At 674, an application in the UE 602 sends traffic or requests a network connection.

At 675, the UE 602 detects new application traffic and determines that application traffic needs to be routed via a PDU session of a specific DNN, S-NSSAI, and/or RAT type. The determination may be based on a configured URSP rule, local configuration or application request. That is, the UE 602 determines that the application traffic matches a URSP rule which defines a specific DNN, S-NSSAI, and/or RAT type.

At 676, the UE 602 requests establishment of a PDU session using a specific S-NSSAI, DNN, SSC mode. Optionally, if the determination in step 671 was made due to a URSP rule the UE 602 may include a URSP indication in the PDU session establishment request. The indication may include an identifier of the URSP rule that triggered the UE to request establishment of a PDU session or may include the Policy Section Identifier of the policy section that contained the URSP rule that triggered the PDU session establishment. Accordingly, the request comprises S-NSSAI, DNN, and/or SSC mode, and optionally a URSP indication.

At 677, the SMF 608 selects an SM-PCF 612 and requests policies by establishing an SM Policy Association. The SMF 608 sends an Npcf_SM_PolicyControl_Create including the SUPI, PDU session ID, DNN, S-NSSAI requested and RAT type of the access that the UE requested establishment of for the PDU session. If the UE included a URSP indication in step 676 the SMF 608 forwards the URSP rule indication to the PCF. The request to establish an SM Policy Association may comprise SUPI, PDU session ID, DNN, S-NSSAI, and/or RAT type).

At 678, the SM-PCF 608 updates the BSF 610 with the address of the SM-PCF 612, the UE ID and S-NSSAI/DNN using the Nbsf_Management_Register SBI.

At 679, the BSF 610 notifies the UE-PCF 604 with the address of the SM-PCF 612, UE ID and S-NSSAI/DNN based on the Nbsf_Managament_Subscribe request from the UE-PCF 604 in step 673. The notification at step 679 may comprise SUPI and/or GPSI, S-NSSAI/DNN, SUPI or GPSI.

At 680, the UE-PCF 604 determines to check for the UE 602 requested PDU session if the UE routes traffic according to a configured URSP rule.

At 681, the UE-PCF 604 triggers the SM-PCF 612 to report non-allowed traffic based on the options described above.

At 682, the SM-PCF 612 configures rules to the SMF 608 to report non-allowed traffic. The SM-PCF 612 may send rules to the SMF 608, the rules for configuring the SMF 608 to report non-allowed traffic.

At 683, the SM-PCF 612 reports non-allowed traffic to the UE-PCF 604.

At 684, the UE-PCF 604 determines if the traffic reported should be sent via a different S-NSSAI or whether traffic should be blocked. The UE-PCF 604 may determine new URSP rules to route traffic via a different network slice. In addition, the SM-PCF 612 may install rules to the SMF 608 to block any detected non-allowed traffic. The SM-PCF 612 makes a determination to install a rule to block non-allowed traffic based on the policy rule provided by the UE-PCF 604 in step 681. Alternatively, the user subscription may include information that indicates to the SM-PCF 612 that it should block any non-allowed traffic.

At 685, the UE-PCF 604 provides updated URSP rules to the UE 602 using the UE Configuration Update for transparent policy delivery.

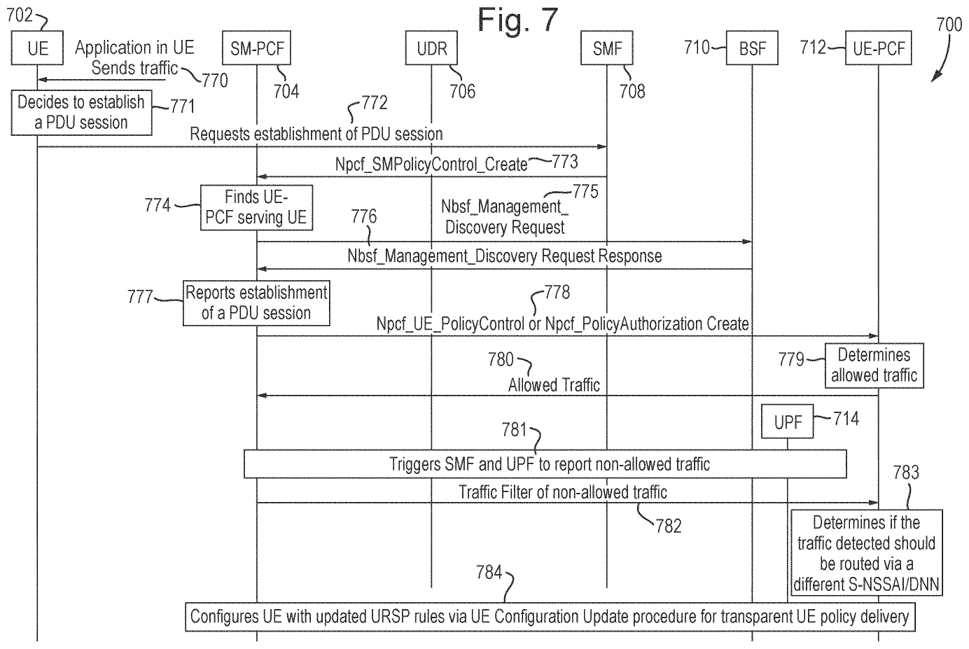

According to another arrangement, an SM-PCF requests that a UE-PCF with policies reports non-allowed traffic. When the SM-PCF receives a Policy Association request to establish a PDU session to SM-PCF also establishes a policy association with the UE-PCF that allows the UE-PCF to determine the allowed traffic. FIG. 7 is a messaging diagram illustrating such a process for policy management in a wireless communication network.

The system illustrated in FIG. 7 shows a UE 702, an SM-PCF 704, a UDR 706, an SMF 708, a BSF 710, a UE-PCF 712, and a UPF 714. The UE 702 may comprise a remote unit 102, a user equipment apparatus 200 or a UE 602 as described herein. The SM-PCF 704 and UE-PCF 712 may each comprise a network unit 104 or a network node 300 as described herein.

The process 700 starts at 770, when an application in the UE 702 sends traffic or requests a network connection.

At 771, the UE 702 detects new application traffic and determines that the new application traffic needs to be routed via a PDU session of a specific DNN, S-NSSAI, and/or RAT type. The determination may be based on a configured URSP rule, a local configuration or an application request. The determination may be based on the new application traffic matching a traffic descriptor of a URSP rule.

At 772, the UE 702 requests establishment of a PDU session using a specific S-NSSAI, DNN, and/or SSC mode. Optionally, if the determination in step 771 was made due to a URSP rule, then the UE 702 may include a URSP indication in the PDU session establishment request. The indication may include an identifier of the URSP rule that triggered the UE 702 to request establishment of a PDU session or may include the Policy Section Identifier of the policy section that contained the URSP rule that triggered the PDU session establishment. As such, the request comprises an indication of S-NSSAI, DNN, and/or SSC mode, and an optional URSP indication.

At 773, the SMF 708 selects an SM-PCF 704 and requests policies by establishing an SM Policy Association. The SMF 708 sends an Npcf_SM_PolicyControl_Create message that includes the SUPI, PDU session ID, DNN, S-NSSAI requested and/or RAT type of the access for which the UE 702 requested establishment of a PDU session. If the UE 702 included a URSP indication in step 772 the SMF 708 forwards the indication to the SM-PCF 704. The policy request may comprise SUPI, PDU session ID, DNN, S-NSSAI, and/or RAT type, and optionally a URSP indication.

At 774, the SM-PCF 704 finds a UE-PCF 712 serving the UE 702.

At 775, the SM-PCF 704 sends an Nbsf_Management_Discovery request including the SUPI/GPSI of the UE 702 to the BSF 710. The Nbsf_Management_Discovery request may comprise the SUPI and/or GPSI.

At 776, the BSF 710 responds with the address of the UE-PCF 712 that serves the UE 702.

At 777, the SM-PCF 704 reports to the UE-PCF 712 establishment of a PDU session using a specific S-NSSAI/DNN.

At 778, the SM-PCF 704 sends an Npcf_UEPolicyControl create or Npcf_policy_authorization or a new SBI indicating the S-NSSAI/DNN of the PDU session requested by the UE 702.

At 779, the UE-PCF 712 determines the traffic allowed from the URSP rule.

At 780, the UE-PCF 712 indicates to the SM-PCF 704 that the SM-PCF 704 should report non-allowed traffic. This indication is provided to the SM-PCF 704 either in the response to step 788 or by triggering a new request.

At 781, the SM-PCF 704 configures rules to the SMF 708 to report non-allowed traffic. That is, the SM-PCF 704 sends rules to the SMF 708, configuring the SMF 708 to report non-allowed traffic.

At 782, the SM-PCF 704 reports non-allowed traffic to the UE-PCF 712.

At 783, the UE-PCF 712 determines if the traffic reported should be sent via a different S-NSSAI or whether traffic should be blocked. The UE-PCF 712 may determine new URSP rules to route traffic via a different slice. In addition, the SM-PCF 704 may install rules on the SMF 708 to block any detected non-allowed traffic. The SM-PCF 704 determines to install a rule to block non-allowed traffic based on the policy rule provided by the UE-PCF 712 in step 780. Alternatively, the user subscription may include information to allow the SM-PCF 704 to block any non-allowed traffic.

At 784, the UE-PCF 712 provides updated URSP rules to the UE 702 using the UE Configuration Update for transparent policy delivery.

Alternatively, the UE-PCF 712 may directly configure the SMF 708 to report non-allowed traffic. The UE-PCF 712 may identify the SMF 708 serving the UE 702 for the established PDU session to a specific S-NSSAI. The UE-PCF 712 may then request that the SMF 708 report any non-allowed traffic, the request sent using an exposure mechanism.

In an additional alternative, after the UE-PCF 712 detects non allowed traffic the UE-PCF 712 may request that the SM-PCF 704 block traffic by sending an appropriate trigger to the SM-PCF 704.

One objective is to identify how to detect that a UE enforces a URSP rule correctly. Some of the known solutions involve the SM-PCF instructing the network to monitor on the PDU session established if the UE routes traffic according to a URSP rule. However, it has not been defined clearly how the SM-PCF is configured to inspect traffic of a PDU session.

The solution presented herein proposes a method for the UE-PCF, that provisions the URSP rule to a UE to check if a UE enforces the URSP rules correctly by configuring the SM-PCF to inspect traffic.

According to one arrangement, a UE-PCF configures an SM-PCF with policies to report non-allowed traffic. According to another arrangement, an SM-PCF requests policies from a UE-PCF when SM-PCF receives a request for policies based on a requested PDU session by a UE.

Accordingly, there is provided a UE-PCF in a first mobile communication network responsible for provisioning URSP policies to a UE. The UE-PCF may be arranged to send a first request to a first network function, which may be the BSF, wherein the request includes a request for providing an identity of a second network function, which may be the SM-PCF, that provides session management policies when a device requests a network connection to a first list of S-NSSAI/DNNs; and receive an identity of the second network function in response to a UE requesting a network connection to one of the first list of S-NSSAI/DNNs. The UE-PCF may be further arranged to determine allowed traffic via the requested UE network connection based on a URSP rule provisioned to the UE; to send a second request to the second network function wherein the request includes a request to install session management policies; and to receive information from the first network with a list of service data flows that are routed incorrectly by the device via the PDU session.

The second request may include an indication to report non-allowed traffic. The second request may include allowed traffic via the S-NSSAI/DNN. The UE-PCF may include a usage monitoring identifier indicating a policy to monitor usage of non-allowed traffic. The UE-PCF may receive the usage monitoring identifier from the UDR based on the UE subscription information.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communication system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations may be relevant in the field of the present document: URSP—UE Routing Selection Policy; PCF—Policy and Charging Function; UE-PCF—PCF responsible for Access and Mobility and UE Policies; SM-PCF—PCF responsible for Session Management Policies; UE—User Equipment; NEF—Network Exposure Function; UDR—Unified Data Repository.

1. An apparatus for wireless communication, comprising:
at least one memory; and
at least one processor coupled with the at least one memory and configured to cause the apparatus to:
send a first request to a session management policy control function (SM-PCF) that instructs the SM-PCF to monitor user equipment (UE) traffic for an established protocol data unit (PDU) session to a specific single-network slice assistance information/data network name (S-NSSAI/DNN); and
receive a report of non-allowed traffic from the SM-PCF that allows a UE policy control function (UE-PCF) to identify if a UE route selection policy (URSP) rule is not enforced correctly by a UE.

2. The apparatus of claim 1, wherein the at least one processor is further configured to cause the apparatus to:
send a preliminary request to a first network function, wherein the preliminary request requests an identity of the SM-PCF that provides session management policies when a device requests a network connection to a first list of S-NSSAI/DNNs; and
receive an identity of a second network function in response to the UE requesting a network connection to one of the first list of S-NSSAI/DNNs.

3. The apparatus of claim 2, wherein the at least one processor is further configured to cause the apparatus to define allowed traffic via the requested UE network connection based on a URSP rule provisioned to the UE.

4. The apparatus of claim 1, wherein the first request comprises instructions to install session management policies.

5. The apparatus of claim 1, wherein the first request comprises instructions to report an occurrence of an event identified by a first event identifier.

6. The apparatus of claim 5, wherein the first event identifier identifies an occurrence where the UE routes non-allowed traffic via the established PDU session.

7. The apparatus of claim 1, wherein the at least one processor is further configured to receive a usage monitoring identifier from a unified data repository (UDR).

8. The apparatus of claim 7, wherein the first request that instructs the SM-PCF to monitor UE traffic when the UE establishes a PDU session to the specific S-NSSAI/DNN includes the usage monitoring identifier from the UDR.

9. A method comprising:
sending a first request to a session management policy control function (SM-PCF) that instructs SM the SM-PCF to monitor user equipment (UE) traffic for an established protocol data unit (PDU) session to a specific single-network slice assistance information/data network name (S-NSSAI/DNN); and
receiving a report of non-allowed traffic from the SM-PCF that allows a UE policy control function (UE-PCF) to identify if a UE route selection policy (URSP) rule is not enforced correctly by a UE.

10. An apparatus for wireless communication, comprising:
at least one memory; and
at least one processor coupled with the at least one memory and configured to cause the apparatus to:
receive a first request from a user equipment (UE) policy control function (UE-PCF) that instructs a session management policy control function (SM-PCF) to monitor UE traffic for an established protocol data unit (PDU) session to a specific single-network slice assistance information/data network name (S-NSSAI/DNN); and
send a report of non-allowed traffic to the UE-PCF that allows the UE-PCF to identify if a UE route selection policy (URSP) rule is not enforced correctly by a UE.

11. The apparatus of claim 10, wherein the first request comprises instructions to install session management policies.

12. The apparatus of claim 11, wherein the first request further comprises instructions to report an occurrence of an event identified by a first event identifier.

13. The SM apparatus of claim 10, wherein the at least one processor is further configured to receive a usage monitoring identifier from a unified data repository (UDR).

14. The apparatus of claim 13, wherein the first request that instructs the SM-PCF to monitor UE traffic when the UE establishes a PDU session to the specific S-NSSAI/DNN includes the usage monitoring identifier from the UDR.

15. A method comprising:
receiving a first request from a user equipment (UE) policy control function (UE-PCF) that instructs a session management policy control function (SM-PCF) to monitor UE traffic for an established protocol data unit (PDU)session to a specific single-network slice assistance information/data network name (S-NSSAI/DNN); and
sending a report to the UE-PCF of non-allowed traffic that allows the UE-PCF to identify if a UE route selection policy (URSP) rule is not enforced correctly by a UE.

16. The method of claim 15, wherein the first request comprises instructions to install session management policies.

17. The method of claim 16, wherein the first request further comprises instructions to report an occurrence of an event identified by a first event identifier.

18. The method of claim 9, further comprising:
sending a preliminary request to a first network function, wherein the preliminary request requests an identity of the SM-PCF that provides session management policies when a device requests a network connection to a first list of S-NSSAI/DNNs; and
receiving an identity of a second network function in response to the UE requesting a network connection to one of the first list of S-NSSAI/DNNs.

19. The method of claim 18, further comprising defining allowed traffic via the requested UE network connection based on a URSP rule provisioned to the UE.

20. The method of claim 9, wherein the first request comprises instructions to report an occurrence of an event identified by a first event identifier.
